(19) United States
(12) Patent Application Publication
(10) Pub. No.: US 2024/0254063 A1
(43) Pub. Date: Aug. 1, 2024

(54) LIQUID FERTILIZERS COMPRISING DISSOLVED FERTILIZER AND SUSPENDED SOLIDS COMPRISING CALCIUM

(71) Applicant: Tessenderlo Group NV, Brussels (BE)

(72) Inventors: Thomas David Fairweather, Phoenix, AZ (US); Sun Young Wallace, Phoenix, AZ (US)

(73) Assignee: Tessenderlo Group NV, Brussels (BE)

(21) Appl. No.: 18/565,122

(22) PCT Filed: Jun. 2, 2022
(86) PCT No.: PCT/EP2022/065037

§ 371 Date: Nov. 29, 2023

(30) Foreign Application Priority Data
Jun. 3, 2021 (EP) 21177585.3

(51) Int. Cl. C05G 5/27; C05G 3/50

(52) U.S. Cl. CPC C05G 5/27; C05G 3/50

(57) ABSTRACT

The present invention relates to liquid fertilizers comprising water; a first fertilizing ingredient dissolved in the aqueous liquid; a solid suspended in the aqueous liquid, wherein the solid comprises calcium; and a polysaccharide rheology modifier; characterized in that the suspended solid has a Dv(25) of 5 micron or more and a Dv(75) of 100 micron or less as determined by laser diffraction. The present invention further relates to methods for producing said liquid fertilizers and the use thereof for fertilization through side dress, soil injection, spray (soil and/or foliar) or fertigation application, preferably spray or fertigation application.

### FIELD OF THE INVENTION

The present invention relates to liquid fertilizers comprising dissolved fertilizer and suspended solids comprising calcium ions. The present invention further relates to methods for producing said liquid fertilizers and the use thereof as fertilizers, in particular in irrigation and fertigation systems.

### BACKGROUND OF THE INVENTION

It is known that aqueous fertilizer compositions in a liquid form present several advantages compared with fertilizer compositions in a solid form. The preparation of such liquid aqueous compositions avoids granulating and drying steps and obviates other drawbacks such as caking or dust formation. Furthermore, liquid aqueous compositions can be used in various application methods such as broadcast soil and sidedress applications, and in particular fertigation or foliar application.

Aqueous fertilizer compositions exist in a liquid form as solutions and/or as suspensions. In solution, the fertilizers are dissolved in water and, in suspension, the fertilizers are still present as a solid phase and have to remain as a stable suspension in water until the fertilizer is used. Settling of the suspension, or salting out, leads to problems such as inaccurate dosing and clogging of irrigation systems or foliar spray systems (e.g. spray bars).

A serious challenge in the formulation of liquid fertilizer resides in (i) the limited solubility of most of the various salts comprising the nutrients themselves, thereby making it difficult to obtain product concentrates, and (ii) the limited stability of suspensions when prepared using a liquid phase already comprising dissolved fertilizers due to high ionic strength of the solution. In many suspension and colloidal systems, increasing ionic strength of the aqueous phase weakens particle-particle and particle-interface repulsive electrostatic forces, leading to destabilization of the suspension.

Calcium and sulfur, along with magnesium are part of secondary nutrients and like the primary nutrients (NPK), are essential for plant health and growth, although in lesser amounts than the primary nutrients. Calcium deficiencies show up as the yellowing of the young leaves or rotting of the fruits. Apples and tomatoes need high levels of calcium prior to harvesting and calcium deficiencies show up as the blossom end rot or bitter pit of fruits of these crops. In addition to its nutrient's importance, calcium plays a major role in the soil structure and texture. There are many sources of calcium used for the “conditioning” of the soil. Soil conditioners containing calcium include lime sulfur, calcium thiosulfate, calcium chloride, calcium nitrate, and calcium sulfate (Gypsum). Gypsum is the most popular soil conditioner for correcting sodic soils or for improving water infiltration, due to its high calcium and sulfur content. Its drawback is limited solubility (maximum solubility is only about 2.4 grams/liter). Traditionally, finely grounded gypsum (commercial calcium sulfate dihydrate) slurry is prepared at the application site by mixing powdered gypsum and water using a gypsum mixing machine deployed in the field. The slurry under agitation is metered into irrigation systems. There are serious challenges with using such gypsum slurries. This method is labour intensive and the thus prepared slurries are prone to plugging the gypsum mixing machine lines, filters, irrigation lines or emitters can happen.

U.S. Pat. No. 5,863,861B1 is directed at providing suspensions of potassium in water for use in drip irrigation.

U.S. Pat. No. 7,695,541B1 is directed at providing fertilizer suspensions comprising a water-insoluble calcium salt selected from the group consisting of calcium carbonate, calcium phosphate tribasic, calcium phosphate dibasic and mixtures thereof, and a water-soluble calcium salt selected from the group consisting of calcium acetate, calcium citrate, calcium chloride, calcium gluconate, calcium hydroxide, calcium lactate, calcium lignosulfate, calcium iodate and mixtures thereof. The examples disclose calcium carbonate particles having a particle size of about 3 microns. Such a small particle size requires extensive milling and generates a lot of dust.

U.S. Pat. No. 6,752,850B1 is directed at providing an aqueous dispersion of calcium carbonate and sulfur, which forms calcium sulfate in situ, in the soil structure. The suspension or dispersing agent is bentonite or polyvinyl alcohol.

It is an object of the present invention to provide a stable aqueous liquid fertilizer comprising large amounts of calcium as well as other plant nutrients. In particular, it is an object to provide an aqueous liquid fertilizer comprising large amounts of calcium as well as other plant nutrients, which is stable upon storage for several months and which can be used in irrigation systems or foliar spray systems (or applied as side dress or directly to the soil by spraying or soil injection) without clogging the apertures or holes of the system.

### SUMMARY OF THE INVENTION

The present inventors have surprisingly found that one or more objects of the invention are achieved by using a rheology modifier, preferably a polysaccharide rheology modifier to suspend solids comprising calcium in a liquid fertilizing bulk. In particular, it was found that the solids comprising calcium can be employed with a reasonably large particle size, such that extensive grinding and dust formation can be avoided. Indeed, as is shown in the appended examples, it was found that despite the high ionic strength of liquid fertilizing solutions, stable suspensions with various solids containing calcium, in particular, gypsum can be achieved.

Hence, the present inventors have for the first time provided a platform of stable liquid fertilizers suitable for use in fertigation or foliar applications (but may also be applied directly to the soil by side dress or by spraying or soil injection) which have a high calcium content and can be provided employing solids containing calcium which have a conventional, commonly available particle size.

In a first aspect of the invention, there is provided a stable aqueous liquid fertilizer comprising
water;
a fertilizing ingredient dissolved in the aqueous liquid;
a solid suspended in the aqueous liquid, wherein the solid comprises calcium; and
a rheology modifier,
   characterized in that the suspended solid has a Dv(25) of 5 micron or more and a Dv(75) of 100 micron or less as determined by laser diffraction.

The rheology modifier is preferably a polysaccharide rheology modifier and is preferably provided in an amount such that the liquid fertilizer has a viscosity within the range of 500-10,000 mPats (cps).

In preferred embodiments, the fertilizer of the invention is provided comprising
10-90 wt. % (by total weight of the liquid fertilizer) water;
at least 5 wt. % (by total weight of the liquid fertilizer) of the first fertilizing ingredient dissolved in the aqueous liquid;
at least 10 wt. % (by total weight of the liquid fertilizer) of the solid suspended in the aqueous liquid; and
at least 0.01 wt. % (by total weight of the liquid fertilizer) a rheology modifier, preferably in an amount such that the fertilizer has a viscosity within the range of 1000-4000 mPa's (cps). The rheology modifier is preferably a polysaccharide rheology modifier.

In particularly preferred embodiments the fertilizer of the invention is provided comprising
10-90 wt. % (by total weight of the liquid fertilizer) water;
at least 5 wt. % (by total weight of the liquid fertilizer) of the first fertilizing ingredient dissolved in the aqueous liquid;
at least 10 wt. % (by total weight of the liquid fertilizer) of the solid suspended in the aqueous liquid; and
at least 0.01 wt. % (by total weight of the liquid fertilizer) of a rheology modifier, preferably in an amount such that the fertilizer has a viscosity within the range of 1000-4000 mPa*s (cps),
   wherein the solid comprises a calcium salt selected from the group consisting of sulfates, phosphates, carbonates, hydrates thereof and combinations thereof; and
   wherein the first fertilizing ingredient is selected from the group consisting of thiosulfate salts, urea, ammonium salts, nitrate salts and combinations thereof. The rheology modifier is preferably a polysaccharide rheology modifier.

In particularly preferred embodiments the fertilizer of the invention is provided comprising
10-90 wt. % (by total weight of the liquid fertilizer) water;
at least 5 wt. % (by total weight of the liquid fertilizer) of the first fertilizing ingredient dissolved in the aqueous liquid;
at least 10 wt. % (by total weight of the liquid fertilizer) of the solid suspended in the aqueous liquid; and
at least 0.01 wt. % (by total weight of the liquid fertilizer) of a rheology modifier, preferably in an amount such that the fertilizer has a viscosity within the range of 1000-4000 mPa*s (cps),
   wherein the solid comprises a calcium salt selected from the group consisting of sulfates, phosphates, carbonates, hydrates thereof and combinations thereof; and
   wherein the first fertilizing ingredient is selected from the group consisting of thiosulfate salts, urea, ammonium salts, nitrate salts and combinations thereof; and
   wherein the rheology modifier is selected from the group consisting of naturally occurring clays, naturally occurring polysaccharides and derivatives thereof, proteins (in particular gelatins and hydrolysates thereof), synthetic polymers, and combinations thereof, wherein derivatives are selected from acetate derivatives, carboxymethyl derivatives, hydroxypropyl derivatives, hydroxypropylmethyl derivatives, methyl derivatives, hydroxyethyl derivatives, hydroxymethyl derivatives, ethylene glycol derivative, and propylene glycol derivatives of the polysaccharides, and wherein the rheology modifier, when added to demineralized water at a concentration of 1 g/100 ml water, results in a viscosity of more than 200 mPa*s (cps); and
   wherein the fertilizer further comprises 0.05-10 wt % (by total weight of the liquid fertilizer) of a dispersant selected from the group consisting of:
sulfonates of branched or straight-chain C₅-C₂₄ alkyls;
sulfonates of alkylnaphthalene groups comprising a C₁-C₁₅ alkyl;
sulfonates of alkylbenzene groups comprising a C₁-C₁₅ alkyl;
phosphate esters of ethoxylated C₅-C₂₄ alkyls;
lignosulfonates.

In another aspect of the invention, there is provided a method for the preparation of a stable aqueous liquid fertilizer comprising the steps of:
(i) providing an aqueous liquid comprising a fertilizer dissolved therein;
(ii) adding to the aqueous liquid provided in step (i) a solid comprising calcium and a rheology modifier to obtain a first blend; and
(iii) submitting the first blend of step (ii) to a mixing step suitable for converting it into a stable aqueous liquid fertilizer.

In another aspect of the invention, there is provided a liquid fertilizer obtainable by the method for the preparation of a stable aqueous liquid fertilizer described herein.

In another aspect of the invention, there is provided the use of the liquid fertilizer for fertilization through side dress, soil injection, spray (soil and/or foliar) or fertigation application, preferably spray or fertigation application. This use optionally comprises diluting the liquid fertilizer of the invention with water before the foliar or fertigation application.

### DETAILED DESCRIPTION

As used herein, the expression “wt. %” when used in the context of an ionic compound (such as a thiosulfate or a sulfate) refers to the amount of the compound inclusive of its counterion.

As used herein, the expression “a stable aqueous liquid fertilizer” should be interpreted to mean that the fertilizer exhibits less than 10% (by total height of the formulation) of water layer development after 14 days storage in a closed container at 54° C. The test is preferably performed with 500 ml of the formulation stored in a graduated cylinder having an inner diameter within the range of 5-6 cm, which is closed with a stopper.

For the purpose of the present disclosure, the amount of suspended solids is determined based on the amount of particles with a particle size above 2 micron, which can easily be determined by the person skilled in the art by filtering particles with a size above 2 micron from an aliquot of fertilizer and determining their weight. Alternatively, the amount of suspended solids can be calculated based on the amount of insoluble material employed in the fertilizer formulation.

In a first aspect of the invention, there is provided a stable aqueous liquid fertilizer comprising
water;
a first fertilizing ingredient dissolved in the aqueous liquid;
a solid suspended in the aqueous liquid, wherein the solid comprises calcium; and
a rheology modifier,
   characterised in that the suspended solid has Dv(25) of 5 micron or more and a Dv(75) of 100 micron or less as determined by laser diffraction.

It will be understood by the skilled person in the context of the present disclosure that the fertilizer ingredient, the suspended solid and the polysaccharide modifier are different compounds.

The particle size distribution of the suspended solid is preferably determined using a laser light diffraction particle size analyzer, such as the Beckman Coulter LS13320 or another instrument of equal or better sensitivity, wherein the particle size distribution is calculated using Mie theory of light scattering, assuming a volume equivalent sphere model. The particle size distribution of the suspended solid is preferably determined on dry powder before the solid is suspended into the liquid fertilizer of the present invention. For this purpose, it is preferred to use the Beckman Coulter LS13320 equipped with a Tornado Dry Powder System. The terms Dv(25) and Dv(75) employed in the context of particle size are known to the skilled person and signify the particle size at which 25% and 75% respectively of the volume distribution is below said particle size.

In preferred embodiments, the suspended solid has Dv(25) of 5 micron or more and a Dv(75) of 55 micron or less as determined by laser diffraction.

The suspended solid comprising calcium preferably has the following additional particle size characteristics:
approximately 100 wt. % of particles pass through a 50 mesh (297 micron) screen, preferably through a 100 mesh (149 micron) screen; and
more than 85 wt. % of particles pass through a 100 mesh (149 micron) screen, preferably through a 200 mesh (74 micron) screen; and
more than 50 wt. % of particles pass through a 200 mesh (74 micron) screen, preferably through a 325 mesh (44 micron) screen.

In preferred embodiments there is provided the liquid fertilizer comprising:
water;
at least 5 wt. % (by total weight of the liquid fertilizer) of a first fertilizing ingredient dissolved in the aqueous liquid;
at least 10 wt. % (by total weight of the liquid fertilizer) of a solid suspended in the aqueous liquid, wherein the solid comprises calcium; and
a rheology modifier,
   characterized in that the suspended solid has a Dv(25) of 5 micron or more and a Dv(75) of 100 micron or less as determined by laser diffraction.

The fertilizer of the invention typically comprises a total amount of 10-90 wt. % (by total weight of the liquid fertilizer) water, preferably 10-70 wt. %, more preferably 15-50 wt. %. The origin of the water present in the fertilizer of the invention depends on how the fertilizer is produced. Although the fertilizer may be produced starting from a solid soluble fertilizing ingredient which is dissolved, the typical and most convenient way to produce the fertilizer will be starting from a liquid product which is produced and sold as such (e.g. Thio-Sul® ammonium thiosulfate, KTS® potassium thiosulfate, CaTs® calcium thiosulfate or MagThio® magnesium thiosulfate available from Tessenderlo Kerley Inc) in case the fertilizing ingredient is a thiosulfate, in which case the water present in the liquid fertilizer of the invention originates partially or completely from the water already present in the liquid product.

A particular advantage of the fertilizer of the present invention is that it can be provided with high amounts of dissolved fertilizing ingredients, and still accommodate suspended solids comprising calcium in the form of a stable suspension. Hence, in preferred embodiments, the fertilizer comprises at least 10 wt. % (by total weight of the liquid fertilizer) of a first fertilizing ingredient dissolved in the aqueous liquid, preferably at least 15 wt. %, more preferably at least 18 wt. %.

Similarly, as is shown in the appended examples, it was found that extremely high loads of suspended solids comprising calcium can be provided in the liquid fertilizer of the present invention. Hence, in preferred embodiments, the fertilizer comprises at least 15 wt. % (by total weight of the liquid fertilizer) of a solid comprising calcium suspended in the aqueous liquid, preferably at least 25 wt. %, more preferably 20 at least 30 wt. %.

Particularly preferred embodiments of the present invention combine high fertilizing ingredient loads with high loads of suspended solids comprising calcium. Hence, in preferred embodiments the fertilizer comprises
at least 15 wt. % (by total weight of the liquid fertilizer) of a solid comprising calcium suspended in the aqueous liquid; and
at least 5 wt. % (by total weight of the liquid fertilizer) of a first fertilizing ingredient dissolved in the aqueous liquid; preferably
at least 25 wt. % (by total weight of the liquid fertilizer) of a solid comprising calcium suspended in the aqueous liquid; and 30
at least 10 wt. % (by total weight of the liquid fertilizer) of a first fertilizing ingredient dissolved in the aqueous liquid;
   more preferably
at least 30 wt. % (by total weight of the liquid fertilizer) of a solid comprising calcium suspended in the aqueous liquid; and
at least 15 wt. % (by total weight of the liquid fertilizer) of a first fertilizing ingredient dissolved in the aqueous liquid.

The first fertilizing ingredient is preferably a source of N, P, K and/or S. The first fertilizing ingredient is preferably employed in an amount such that the total combined amount of N, P, K and S provided by the first fertilizing ingredient is more than 5 wt. % (by total weight of the formulation), preferably more than 10 wt. %. Preferably, the total combined amount of N and S provided by the first fertilizing ingredient is more than 5 wt. % (by total weight of the formulation), preferably more than 10 wt. %. It will be understood by the skilled person that the first fertilizing ingredient may be provided in the form of a hydrate. In case the fertilizing ingredient comprises a salt in the form of a hydrate, for the purpose of wt. % calculations, the mass of the water of hydration is included in the mass of the first fertilizing ingredient. 45

In preferred embodiments, the first fertilizing ingredient is a source of S selected from thiosulfate salts. The thiosulfate salt can in principle be any of the common thiosulfate salts, such as the alkaline metal thiosulfate salts, alkaline earth metal thiosulfate salts and ferrous thiosulfates. However, since plants do not tolerate sodium thiosulfate well, the thiosulfate salt is preferably selected from the group consisting of calcium thiosulfate, magnesium thiosulfate, potassium thiosulfate, ammonium thiosulfate, manganese thiosulfate, ferrous thiosulfate and combinations thereof, more preferably the thiosulfate salt is selected from the group consisting of calcium thiosulfate, potassium thiosulfate, ammonium thiosulfate and combinations thereof. As is shown in the appended examples, the present inventors have found a further unexpected advantage when a major amount of calcium thiosulfate in the liquid phase is combined with a minor amount of another thiosulfate (such as ammonium thiosulfate or potassium thiosulfate). The minor amount of another thiosulfate was found to provide an unexpected and large additional stabilizing effect to the liquid fertilizer, significantly extending its stable shelf-life. Hence, in particular embodiments, the fertilizing ingredient comprised in the liquid fertilizer of the present invention consists of a combination of a first thiosulfate salt and a second thiosulfate salt, wherein the first thiosulfate salt is calcium thiosulfate and the second thiosulfate salt is selected from magnesium thiosulfate, potassium thiosulfate, ammonium thiosulfate, manganese thiosulfate, ferrous thiosulfate and combinations thereof, preferably the second thiosulfate is selected from ammonium thiosulfate, potassium thiosulfate and combinations thereof, most preferably the second thiosulfate is ammonium thiosulfate. In these embodiments:
the ratio (w/w) of the first thiosulfate to the second thiosulfate is preferably within the range of 1:1 to 10:1, preferably within the range of 2:1 to 6:1; and/or
the concentration of the first thiosulfate is preferably more than 3 wt. % (by total weight of the liquid fertilizer), more preferably more than 5 wt. % and the concentration of the second thiosulfate is preferably within the range of 0.1-5 wt. %, more preferably within the range of 0.5-3 wt. %.

In preferred embodiments, the first fertilizing ingredient is a source of N selected from urea, ammonium salts, nitrate salts and combinations thereof. Preferred nitrate salts are ammonium nitrate, calcium nitrate, potassium nitrate and combinations thereof. In more preferred embodiments the first fertilizing ingredient is a source of N selected from urea, ammonium nitrate, and combinations thereof. In such embodiments, the first fertilizing ingredient is preferably provided in an amount such that the total amount of N provided by the first fertilizing ingredient is more than 6 wt. % (by total weight of the formulation), preferably more than 8 wt. %.

In preferred embodiments, the first fertilizing ingredient is a source of P selected from monocalcium phosphate, dicalcium phosphate, monoammonium phosphate, diammonium phosphate, ammonium polyphosphate, monopotassium phosphate, dipotassium phosphate, and combinations thereof.

In preferred embodiments, the first fertilizing ingredient is a source of K selected from potassium sulfate, potassium bisulfate, potassium chloride, potassium thiosulfate, potassium carbonate, potassium nitrate, monopotassium phosphate, dipotassium phosphate, and combinations thereof. As is known to the skilled person, while most potassium sulfate is only partially water-soluble and difficult to dissolve, water-soluble forms of potassium sulfate exist (due to a combination of a particularly high degree of purity and particular particle size) and are commercially available e.g. sold as Solupotasse® by Tessenderlo Kerley.

The solid suspended in the aqueous liquid of the fertilizer of the present invention preferably comprises a calcium salt selected from the group consisting of sulfates, phosphates, carbonates, hydrates thereof and combinations thereof. In embodiments, the solid comprises more than 50 wt. % (by total weight of the solid) of the calcium salt, preferably more than 80 wt. %, more preferably more than 95 wt. %. In embodiments, the solid consists essentially of the calcium salt. It will be understood by the skilled person that the calcium salt may be provided in the form of a hydrate, which is typical for calcium sulfate (the dihydrate form thereof is commonly known as “gypsum”). In case the solid comprises a calcium salt in the form of a hydrate, for the purpose of wt. % calculations, the mass of the water of hydration is included in the mass of the calcium salt. As used herein, the term “phosphates” encompasses monobasic, dibasic and tribasic phosphates, diphosphates, polyphosphates, hydrates thereof, and combinations thereof. As is known to the skilled person, phosphates are often obtained and sold as mixtures of the aforementioned phosphate compounds. In highly preferred embodiments the solid comprises or consists of gypsum, which includes synthetic gypsum, recycled gypsum or mined gypsum. In a specifically envisaged embodiment of the present invention, the solid is gypsum, and the total amount of calcium in the liquid fertilizer is more than 10 wt. % and the total amount of nitrogen and/or sulfur in the liquid fertilizer is more than 10 wt. %. In case the calcium salt is a phosphate salt, the phosphate salt preferably comprises a major amount of monocalcium phosphate Ca(H₂PO₄)₂ or a hydrate thereof, such as more than 60 wt. % or more than 80 wt. % (by total weight of the phosphate salt).

The rheology modifier included in the liquid fertilizer of the invention can be any rheology modifier which, according to preferred embodiments, when add to demineralized water at a concentration of 1 g/100 ml water, results in a viscosity of more than 200 mPa*s (cps) as determined by “the viscosity protocol” defined herein elsewhere. Examples of such rheology modifiers may be found among naturally occurring clays (e.g. smectite, kaolinite, attapulgite), naturally occurring polysaccharides (e.g. gums) and derivatives thereof, proteins (in particular gelatins and hydrolysates thereof) or synthetic polymers. Suitable derivatives include the naturally occurring polysaccharides modified with acetate, carboxymethyl, hydroxypropyl, hydroxypropylmethyl, methyl, hydroxyethyl, hydroxymethyl, ethyleneglycol or propylene glycol.

Examples of suitable synthetic polymer rheology modifiers include polyacrylamides, polyacrylates, polyvinylpyrrolidones, polyamides (e.g. aromatic polyamides), polysulfonic acids, polyurethanes, polystearates, polyethers (e.g. polyethlene glycol), silicone-based polymers (e.g. polysiloxanes), alkylene oxide polymers, polyquaterniums.

Clays include exfoliated clays.

Proteins include any polypeptide rheology modifier without restriction to chain length. Particularly preferred protein rheology modifiers are gelatins and hydrolysates thereof. Gelatins hydrolysates in particular include hydrolyzed collagen (also called collagen hydrolysates or collagen peptides).

The present inventors have found that polysaccharides are superior rheology modifiers for suspending the solids comprising calcium in the liquid fertilizer of the present invention, especially when considering improved shelf-life stability and reduced risk of salting deposition/clogging during irrigation, for example, compared to clay rheology modifiers. Examples of suitable rheology modifiers, which are preferably polysaccharide rheology modifiers are the compounds in the following group, provided that when the compound is added to demineralized water at a concentration of 1 g/100 ml water, it results in a viscosity of more than 200 mPa's (cps) as determined by “the viscosity protocol” defined herein elsewhere: acacia gums, agar, arabic gums, arabinan, alginic acid or a salt thereof, apiogalacturonan, arthrobacter viscosus NRRL 1973 Exopolysaccharide, arthrobacter stabilis NRRL B3225 Exopolysaccharide, carrageenans, celluloses (e.g. MCC, CMC, MC and HPMC), chitin, chitosan, chondroitin sulfates, fucosylated chondroitin sulfates, colominic acid or a salt thereof, curdlan, dermatan sulfates, dextrans, diutan gums, fructans (e.g. inulins), fucoidans, furcellaran, gellan gums, ghatti gum, glycogen, hemicelluloses (e.g. mannans, galactomannans (in particular guar gum), xyloglucans, xylans, glucomannans, arabinoxylans, β-glucans (in particular from cereal, yeast, or fungi), arabinogalactans), hyaluronic acid or a salt thereof, ivory nut mannan, konjac, karaya gum, laminaran, levan, lichenan, isolichenan, locust bean gums, mucilage gums (e.g. yellow mustard mucilage, flaxseed mucilage, pysillium gum), pachyman, pachymaran, pectin, pectic arabinogalactans, pectic rhamnogalacturonans, peptidoglycan, polysialic acid or a salt thereof, porphyran, pullulan, putstulan, schizophyllans, scleriotium gums, scleroglucan, starches, tamarind gum, tara gum, teichuronic acids, tragacanth gum, ulvan, welan gum, xanthan gums, xylans, zymosan, derivatives thereof and combinations thereof. Suitable derivatives include acetate derivatives, carboxymethyl derivatives, hydroxypropyl derivatives, hydroxypropylmethyl derivatives, methyl derivatives, hydroxyethyl derivatives, hydroxymethyl derivatives, ethylene glycol derivative, and propylene glycol derivatives of the aforementioned polysaccharides. Preferred polysaccharide rheology modifiers within this group are water-soluble polysaccharides, wherein the expression “water-soluble polysaccharide” refers to a polysaccharide having a solubility of at least 0.5 g/100 ml water at 20° C.

As will be understood by the skilled person in the context of the present disclosure, the expression “Suitable derivatives include acetate derivatives, carboxymethyl derivatives, hydroxypropyl derivatives, hydroxypropylmethyl derivatives, methyl derivatives, hydroxyethyl derivatives, hydroxymethyl derivatives, ethylene glycol derivative, and propylene glycol derivatives of the aforementioned polysaccharides” or similar variants thereof is identical to the expression “Suitable derivatives include the aforementioned polysaccharides modified with acetate, carboxymethyl, hydroxypropyl, hydroxypropylmethyl, methyl, hydroxyethyl, hydroxymethyl, ethyleneglycol or propylene glycol”.

The present inventors have found that some gums result in a surprising further improved stability of the thiosulfate based suspensions of the present invention. Hence, it is preferred that the rheology modifier is selected from starch or a derivative thereof, xanthan gum or a derivative thereof, guar gum or a derivative thereof, diutan gum or a derivative thereof, locust bean gum or a derivative thereof, and combinations thereof. Suitable derivatives include acetate derivatives, carboxymethyl derivatives, hydroxypropyl derivatives, hydroxypropylmethyl derivatives, methyl derivatives, hydroxyethyl derivatives, hydroxymethyl derivatives, ethylene glycol derivative, and propylene glycol derivatives of these polysaccharides. Preferred derivatives include hydroxypropyl derivatives, hydroxypropylmethyl derivatives, hydroxyethyl derivatives, and hydroxymethyl derivatives of these polysaccharides. In other words, suitable derivatives include these polysaccharides (i.e. starch, xanthan gum, guar gum, diutan gum, locust bean gum, and combinations thereof) modified with acetate, carboxymethyl, hydroxypropyl, hydroxypropylmethyl, methyl, hydroxyethyl, hydroxymethyl, ethyleneglycol or propylene glycol. Preferred derivatives include these polysaccharides (i.e. starch, xanthan gum, guar gum, diutan gum, locust bean gum, and combinations thereof) modified with hydroxypropyl, hydroxypropylmethyl, hydroxyethyl, or hydroxymethyl. In particular, these gums provided a surprising, further improved performance over other polysaccharidic rheology modifiers such as carrageenans, alginic acid, sclerotium gum and phyto-gel.

Particularly preferred are embodiments of the present invention wherein the rheology modifier consists of a first rheology modifier selected from xanthan gum combined with a second rheology modifier selected from starch or a derivative thereof and guar gum or a derivative thereof, preferably guar gum or a derivative thereof. Suitable starch or guar gum derivatives include acetate derivatives, carboxymethyl derivatives, hydroxypropyl derivatives, hydroxypropylmethyl derivatives, methyl derivatives, hydroxyethyl derivatives, hydroxymethyl derivatives, ethylene glycol derivative, and propylene glycol derivatives. Preferred starch or guar gum derivatives include hydroxypropyl derivatives, hydroxypropylmethyl derivatives, hydroxyethyl derivatives, and hydroxymethyl derivatives. In other words, suitable derivatives include starch or guar gum modified with acetate, carboxymethyl, hydroxypropyl, hydroxypropylmethyl, methyl, hydroxyethyl, hydroxymethyl, ethyleneglycol or propylene glycol. Preferred derivatives include starch or guar gum modified with modified with hydroxypropyl, hydroxypropylmethyl, hydroxyethyl, or hydroxymethyl. In such embodiments the ratio (w/w) of the first rheology modifier to the second rheology modifier is preferably within the range of 10:1 to 1:2, preferably within the range of 10:1 to 1:1, more preferably within the range of 5:1 to 1:1, most preferably within the range of 2:1 to 1:1.

In accordance with preferred embodiments of the present invention, the rheology modifier is included in an amount of at least 0.01 wt. % (by total weight of the liquid fertilizer), such as within the range of 0.01-15 wt. % (by total weight of the liquid fertilizer), preferably within the range of 0.01-5 wt. % (by total weight of the liquid fertilizer), preferably within the range of 0.05-2 wt. % (by total weight of the fertilizer), more preferably within the range of 0.1-1 wt. % (by total weight of the liquid fertilizer).

The rheology modifier is typically included in an amount such that the resulting fertilizer has a viscosity of 500-10000 mPa*s (cps) as determined by “the viscosity protocol” defined herein elsewhere, preferably has a viscosity of 1000-4000 mPa's (cps), more preferably has a viscosity of 1400-3200 mPa*s (cps), more preferably has a viscosity of 1700-3000 mPa's (cps), more preferably has a viscosity of 2000-2700 mPa*s (cps).

The present inventors have found that it is possible to provide remarkably stable fertilizer formulations according to the invention. Hence, the fertilizer of the present invention preferably further exhibits the following stability characteristics:
a pH change of less than one pH unit, preferably less than 0.5 pH units after 14 days storage in a closed container at 54° C.; and
a change in thiosulfate content of less than 1 wt. %, preferably less than 0.5 wt. % after 14 days storage in a closed container at 54° C.; and
a viscosity change of less than 10% after 14 days storage in a closed container at 54° C., wherein the viscosity is determined by “the viscosity protocol” defined herein elsewhere;
   wherein the stability test is preferably performed with 500 ml of the formulation stored in a graduated cylinder having an inner diameter within the range of 5-6 cm, which is closed with a stopper. It was also found that although a small water layer does develop after prolonged storage, the formulation is easily resuspended without need for intensive mixing or special equipment.
   A suitable method to determine the thiosulfate content is using the triple titration method which is generally known in the art and is described in ISO3619 (1994).

The fertilizer of the present invention preferably has a pH within the range of 5 to 9, preferably within the range of 7-9. pH adjustment of the fertilizer can be done using any acid or base conventionally used in the fertilizer industry for pH adjustment, such as, but not limited to: sulfuric acid, KOH, HCl, acetic acid, formic acid, nitric acid, citric acid, phosphoric acid, carbonates, etc. A particular advantage of the fertilizers of the present invention is that surprisingly no pH adjustment is necessary after formulation in order to bring the pH within a suitable range for plants, hence a process step is eliminated.

The present inventors have found that the ease of preparing the suspension, as well as the stability of the suspension, may further be improved by including a dispersant. Dispersants are known to the skilled person and are a group of surfactants which work at the solid-liquid interface to stabilize solid particles against flocculation. Preferred dispersants for use in the context of the present invention are anionic surfactants. Preferably, the dispersant consists of one or more anionic surfactants selected from salts (preferably the alkaline metal or alkaline earth metal salt) of a compound represented by R—X; wherein X represents a sulfate group, a phosphate group, a sulfonate group, or a carboxylate group, preferably X represents a phosphate or sulfonate group; and wherein R is selected from:
branched or straight chain C₅-C₂₄ alkyls;
branched or straight chain mono-unsaturated C₅-C₂₄ alkenyls;
branched or straight chain poly-unsaturated C₅-C₂₄ alkenyls;
alkylbenzene groups comprising a C₁-C₁₅ alkyl;
alkenylbenzene groups comprising a C₂-C₁₅ alkenyl;
alkylnaphthalene groups comprising a C₁-C₁₅ alkyl;
alkenylnaphthalene groups comprising a C₂-C₁₅ alkenyl;
alkylphenol groups comprising a C₁-C₁₅ alkyl;
alkenylphenol groups comprising a C₂-C₁₅ alkenyl;
succinic acid esters comprising two C₈-C₁₅ alkyls;
ethoxylated C₅-C₂₄ alkyls;
C₅-C₂₄ fatty acid methyl esters, optionally comprising one or more hydroxyl groups; and
lignins.

The present inventors have found that the following dispersants outperform other dispersants when considering the ease of preparing the suspension, as well as the stability of the suspension. Hence, in preferred embodiments of the invention the dispersant is preferably selected from the group consisting of:
sulfonates of branched or straight chain C₅-C₂₄ alkyls;
sulfonates of alkylnaphthalene groups comprising a C₁-C₁₅ alkyl;
sulfonates of alkylbenzene groups comprising a C₁-C₁₅ alkyl;
phosphate esters of ethoxylated C₅-C₂₄ alkyls;
lignosulfonates; and
combinations thereof.

An non-limiting example of a suitable sulfonate of branched or straight chain C₅-C₂₄ alkyls is an octanesulfonate salt (e.g. a potassium salt).

An non-limiting example of a suitable sulfonate of alkylnaphthalene groups comprising a C₁-C₁₅ alkyl is Morwet D-400 available from Nouryon

An non-limiting example of a suitable sulfonate of alkylbenzene groups comprising a C₁-C₁₅ alkyl is a xylene sulfonate salt (e.g. potassium salt), which is widely commercially available.

An non-limiting example of a suitable phosphate ester of ethoxylated C₅-C₂₄ alkyls is a tridecyl alcohol ethoxylate phosphate ester salt (e.g. potassium salt), which is widely commercially available.

In accordance with preferred embodiments of the present invention, the dispersant is included in an amount within the range of 0.05-10 wt % (by total weight of the liquid fertilizer), preferably 0.1-8 wt. %, more preferably 0.5-5 wt. %.

The present inventors have found that the ease of preparing the suspension, as well as the stability of the suspension, may further be improved by including a wetting agent. Wetting agents are known to the skilled person and are a group of surfactants which work at the air-water interface to lower the surface tension of water and facilitate substituting air in agglomerate particles by liquid. Preferred wetting agents for use in the context of the present invention are non-ionic surfactants such as alcohol ethoxylates, fatty acid ethoxylates, ethoxylated amines, ethoxylated fatty acid amides, poloxamers, fatty acid esters of glycerol, fatty acid esters of sorbitol, fatty acid esters of sucrose, alkyl polyglucosides and combinations thereof. The present inventors have found that alcohol ethoxylates significantly outperform other wetting agents when considering the ease of preparing the suspension, as well as the stability of the suspension. Hence, the wetting agent is preferably selected from the group consisting of alcohol ethoxylates, such as linear C₆-C₁₅ ethoxylates, alkylphenol ethoxylates (such as octylphenol or nonylphenol ethoxylates) and combinations thereof. Preferred alcohol ethoxylates are C₉-C₁₁ alkyl ethoxylates (such as Biosoft® N91-6 available from Stepan) and nonylphenol ethoxylates.

In accordance with preferred embodiments of the present invention, the wetting agent is included in an amount within the range of 0.05-10 wt % (by total weight of the liquid fertilizer), preferably 0.1-5 wt. %, more preferably 0.5-2 wt. %.

The liquid fertilizer of the present invention may include further additives, such as (but not limited to) a biocide, an antifoam agent, a corrosion inhibitor, an antiscaling agent, a fungicide, a herbicide, an insecticide, a nematicide, a biostimulant, chelated metals, other fertilizing ingredients, etc.

A biocide is an antimicrobial agent which can limit the growth of any bacteria or fungus in the formulation, thus maintaining stability and preventing spoilage of the formulation during long term storage. Exemplary biocides are 5-chloro-2-methyl-2H-isothiazol-3-one, 2-methyl-2H-isothiazol-3-one, bronopol (2-bromo-2-nitropropane-1,3-diol), sodium nitrite, 1,2-benzisothiazolin-3-one, glutaraldehyde, sodium o-phenylphenate, 2,2-dibromo-3-nitrilopropionamide, sodium hypochlorite, trisodium phosphate, and combinations thereof. A biocide is typically used in a concentration of 0.005-0.5 wt. % (by total weight of the liquid fertilizer), preferably 0.01-0.2 wt. %.

An antifoam agent is a chemical additive that reduces and hinders the formation of foam during production and use of the liquid fertilizer. Exemplary antifoam agents are polyolefins, polyalkylene oxides, polydimethylsiloxanes, stearates, polyalkylene glycols, and combinations thereof. An antifoam agent is typically used in a concentration of 0.005-0.5 wt. % (by total weight of the liquid fertilizer), preferably 0.01-0.15 wt. %.

Examples of other fertilizing ingredients employed in the fertilizer, such as may be dissolved in the liquid fertilizer, include a source of macronutrients selected from N, P, K, S, Ca, or Mg and/or a source of micronutrients selected from Fe, B, Cl, Mn, Zn, Cu, Mo, Ni, V, Co.

In another aspect, the present invention concerns a method for the preparation of a fertilizer as described herein comprising the steps of:
(i) providing an aqueous liquid comprising a first fertilizing ingredient salt dissolved therein;
(ii) adding to the aqueous liquid provided in step (i) a solid comprising calcium and a rheology modifier to obtain a first blend; and
(iii) submitting the first blend of step (ii) to a mixing step suitable for converting it into a stable aqueous liquid fertilizer.

As will be understood by the skilled person, all embodiments described herein for the liquid fertilizer of the invention, for example relating to the identity and concentrations of the different components, or the stability and viscosity of the resulting product are equally applicable to the method for the preparation of the fertilizer.

It was advantageously found that the compositions of the present invention do not require special high-energy input mixing in order to achieve a stable suspension. Hence, the mixing in step (iii) can be performed by hand mixing using a spatula, by a regular magnetic stir bar or by a hand-held kitchen mixer. While high-shear mixers can be employed, the present inventors found that they are not necessary and even not desirable as they tend to break down the rheology modifier if employed at too high intensities or for too long. A standard fertilizer liquid blender can be used at low shear.

The method may comprise an additional step of adding water to the aqueous liquid of step (i), to the first blend of step (ii) or during the mixing of step (iii). The solid added in step (ii) of the method may be added as a dry product, or in the form of a suspension or slurry, such as an aqueous suspension or slurry. The rheology modifier added in step (ii) of the method may be added as a dry product, or in the form of a mixture with water, which can take the identity of e.g. a solution, suspension, slurry or simply a hydrated rheology modifier. Preferably the rheology modifier added in step (ii) is added in the form of a mixture with water.

Advantageously, the method of the present invention allows the liquid fertilizer to be prepared from commercially available liquid fertilizers, starting from a liquid fertilizing product which is produced and sold as such (e.g. Thio-Sul®, KTS®, CaTs® or MagThio® available from Tessenderlo Kerley Inc in case the first fertilizing ingredient is a thiosulfate). As explained herein elsewhere, it was surprisingly found that these products, which already contain high thiosulfate concentrations close to the solubility limit, can be used as liquid bulk for providing stable suspensions of further solids. Hence, in preferred embodiments, step (i) of the method comprises providing an aqueous liquid comprising a thiosulfate salt dissolved therein, wherein the aqueous liquid contains:
ammonium thiosulfate in an amount resulting in a nitrogen content (as ammoniacal nitrogen) of more than 10 wt. % (by total weight of the aqueous liquid provided in step (i)) and a sulfur content of more than 26 wt. % (by total weight of the aqueous liquid provided in step (i));
potassium thiosulfate in an amount resulting in a potassium content (as K₂O) of more than 22 wt. % (by total weight of the aqueous liquid provided in step (i)) and a sulfur content of more than 15 wt. % (by total weight of the aqueous liquid provided in step (i));
calcium thiosulfate in an amount resulting in a calcium content of more than 5 wt. % (by total weight of the aqueous liquid provided in step (i)) and a sulfur content of more than 8 wt. % (by total weight of the aqueous liquid provided in step (i)); or
magnesium thiosulfate in an amount resulting in a magnesium content of more than 3 wt. % (by total weight of the aqueous liquid provided in step (i)) and a sulfur content of more than 8 wt. % (by total weight of the aqueous liquid provided in step (i));
   preferably
ammonium thiosulfate in an amount resulting in a nitrogen content (as ammoniacal nitrogen) of more than 10 wt. % (by total weight of the aqueous liquid provided in step (i)) and a sulfur content of more than 26 wt. % (by total weight of the aqueous liquid provided in step (i)).

In another aspect, the invention concerns the use of the liquid fertilizer as provided herein for providing nutrients to plants. In particular, there is provided the use of the liquid fertilizer as provided herein for fertilization through side dress, soil injection, spray (soil and/or foliar) or fertigation application, preferably spray or fertigation application. This use optionally comprises diluting the liquid fertilizer of the invention with water before the spray or fertigation application. Typically spray application will be in the form of foliar application, but could also be spray application applied directly to soil or injected into the soil.

In another aspect the invention concerns the use of a thiosulfate salt selected from magnesium thiosulfate, potassium thiosulfate, ammonium thiosulfate, manganese thiosulfate, ferrous thiosulfate and combinations thereof, preferably selected from ammonium thiosulfate, potassium thiosulfate and combinations thereof, most preferably ammonium thiosulfate, to improve the stability of a liquid fertilizer product comprising at least 5 wt. % (by total weight of the liquid fertilizer) of calcium thiosulfate dissolved in the aqueous liquid, and at least 10 wt. % (by total weight of the liquid fertilizer) of a solid suspended in the aqueous liquid. In preferred embodiments, the use to improve the stability of the liquid fertilizer product comprises increasing the time until visible phase separation occurs when the liquid fertilizer is stored in a closed recipient and not agitated. Preferably the time until visible phase separation occurs is increased by at least 20%, preferably by at least 50% compared to a control which has an otherwise identical composition but wherein all thiosulfates other than calcium thiosulfate are replaced by an equal weight amount of calcium thiosulfate.

### EXAMPLES

The composition described in the following examples were prepared by a simple protocol consisting of (i) providing the thiosulfate salt in the form of an aqueous solution; (ii) addition of the solid into the aqueous thiosulfate solution, together with some water, and mixing for 5 minutes to create a suspension; (iii) hydrating the rheology modifier; (iv) addition of the hydrated rheology modifier and any other ingredients into the suspension and mixing by hand using a spatula or using a magnetic stir bar. Hydrating the rheology modifier can be done by simply adding water to the rheology modifier and waiting about 24 hours. Hydration can be sped up by adding an aqueous solution of wetting agent (if employed in the formulation) to the rheology modifier.

The calcium thiosulfate, ammonium thiosulfate and potassium thiosulfate referred to in the below tables were provided in the form of a thiosulfate solution, namely CaTs® (24% calcium thiosulfate, 76% water), Thio-Sul® (58% ammonium thiosulfate, 42% water) and KTS® (50% potassium thiosulfate, 50% water) respectively, available from Tessenderlo Kerley Inc. The tables list the amount of thiosulfate salt as such, and the total amount of water present in the formulation, which includes water originating from the thiosulfate solution as well as additional water which was added when preparing the suspension and when hydrating the rheology modifier to reach the listed total amount of water.

The following protocol was used to determine the viscosity of the liquid fertilizers (referred to throughout the present disclosure as “The viscosity protocol”): The viscosity is measured employing a Brookfield DV3T Rheometer. 15 mL of the formulation is transferred to a small sample adaptor and agitated for 5 minutes at 30 rpm using an SC4-27 spindle. The reference temperature is set at 23ºC and the percent torque reads over 10%. The viscosity in centipoise is taken at the 5-minute mark.

The calcium polysulfide was provided in the form of a polysulfide solution comprising 24% calcium polysulfide and 76% water. The table lists the amount of polysulfide salt as such, and the total amount of water present in the formulation, which includes water originating from the polysulfide solution as well as additional water which was added to reach the listed total amount of water.

The gypsum employed was premium 97 solution grade gypsum sold by Diamond K, containing 97.1% calcium sulfate dihydrate and having a granulation pattern wherein 100% of gypsum passes through a #100 mesh screen, 99% passes through a #200 mesh screen and 85% passes through a #325 mesh screen. The particle size characteristics as determined on dry powder by a Beckman Coulter LS13320 employing a Tornado Dry Powder System were as follows: Dv(10): 1.8 micron; Dv(25): 8.1 micron; Dv(50): 24.7 micron; Dv(75): 51.9 micron; Dv(90): 79.8 micron. The Beckman Coulter LS13320 is a laser light diffraction particle size analyzer wherein the particle size distribution is calculated using Mie theory of light scattering, assuming a volume equivalent sphere model.

The modified starch was provided in the form of a 10 wt. % aqueous solution (the amount of water being included in the total amount of water listed in the below table). The starch solution was heated before adding the starch to the rest of the formulation, in order to promote gelling behaviour.

Example (amounts in wt. %)

| Function | Compound | 1 | 2 | 3 | 4 | 5 |
|---|---|---|---|---|---|---|
| Dissolved fertilizer | Calcium thiosulfate | 10.03 | 10.03 | 10.03 | 6.05 | 6.05 |
| Suspended fertilizer | Gypsum | 41.20 | 41.20 | 41.20 | 45.50 | 45.50 |
| Rheology modifier | Xanthan Gum | 0.14 | 0.20 | 0.20 | 0.17 | 0.17 |
| Rheology modifier | Modified Starch | 0.50 | 0 | 0 | 0 | 0 |
| Rheology modifier | Modified Guar | 0 | 0 | 0 | 0.12 | 0.12 |
| Biocide | Proxel GXL | 0.10 | 0.10 | 0.10 | 0.10 | 0.10 |
| Wetting agent | Alcohol Ethoxylate | 1.00 | 1.00 | 0 | 1.50 | 0.00 |
| Dispersant | Xylene sulfonate | 0 | 0 | 1.00 | 0 | 1.50 |
| Dispersant | Lignosulfonate | 1.50 | 0 | 0 | 0 | 0 |
| Dispersant | Tridecyl alcohol | 0 | 1.50 | 1.50 | 3.00 | 3.00 |
| | ethoxylate | | | | | |
| | phosphate ester, | | | | | |
| | potassium salt | | | | | |
| Continuous phase | Water | 45.53 | 45.97 | 45.97 | 43.57 | 43.57 |

| | | | | | |
|---|---|---|---|---|---|
| Total | 100 | 100 | 100 | 100 | 100 |

Example (amounts in wt. %)

| Function | Compound | 6 | 7 | 8 | 9 |
|---|---|---|---|---|---|
| Dissolved fertilizer | potassium thiosulfate | 8.00 | 0 | 0 | 18.00 |
| Dissolved fertilizer | ammonium thiosulfate | 0 | 9.28 | 20.88 | 0 |
| Suspended fertilizer | Gypsum | 45.50 | 45.50 | 0 | 0 |
| Suspended fertilizer | CaCO₃ | 0 | 0 | 44.00 | 44.00 |
| Rheology modifier | Xanthan Gum | 0.18 | 0.18 | 0.18 | 0.18 |
| Rheology modifier | Modified Guar | 0.10 | 0.10 | 0 | 0 |
| Biocide | Proxel GXL | 0.10 | 0.10 | 0.10 | 0.10 |
| Wetting agent | Alcohol Ethoxylate | 1.50 | 1.50 | 0 | 0 |
| Wetting agent | Nonylphenol ethoxylate | 0 | 0 | 0 | 0 |
| Dispersant | Sodium alkane sulfonate | 0 | 0 | 1.50 | 1.50 |
| Dispersant | Lignosulfonate | 3.00 | 3.00 | 3.00 | 3.00 |
| Continuous phase | Water | 41.64 | 40.36 | 30.34 | 33.22 |

| | | | | |
|---|---|---|---|---|
| Total | 100 | 100 | 100 | 100 |

Example (amounts in wt. %)

| Function | Compound | 10 | 11 | 12 | 13 | 14 |
|---|---|---|---|---|---|---|
| Dissolved fertilizer | potassium thiosulfate | 0 | 0 | 0 | 0 | 1.5 |
| Dissolved fertilizer | ammonium thiosulfate | 19.72 | 0 | 0 | 1.74 | 0 |
| Dissolved fertilizer | calcium thiosulfate | 0 | 10.03 | 6.05 | 6.05 | 6.05 |
| Suspended fertilizer | monocalcium phosphate (anhydrous) | 34.00 | 0 | 0 | 0 | 0 |
| Suspended fertilizer | Gypsum | 0 | 41.20 | 45.50 | 45.50 | 45.50 |
| Rheology modifier | Xanthan Gum | 0.19 | 0 | 0.17 | 0.17 | 0.17 |
| Rheology modifier | Diutan Gum | 0 | 0.12 | 0 | 0 | 0 |
| Rheology modifier | Modified Guar | 0 | 0 | 0.12 | 0.12 | 0.12 |
| Biocide | Proxel GXL | 0.10 | 0.10 | 0.10 | 0.10 | 0.10 |
| Wetting agent | Alcohol Ethoxylate | 1.50 | 1.00 | 1.50 | 1.50 | 1.50 |
| Dispersant | Lignosulfonate | 3.00 | 1.50 | 3.00 | 3.00 | 3.00 |
| Continuous phase | Water | 41.50 | 46.05 | 43.6 | 41.83 | 42.07 |

| | | | | | |
|---|---|---|---|---|---|
| Total | 100 | 100 | 100 | 100 | 100 |

Example (amounts in wt. %)

| Function | Compound | 15 | 16 |
|---|---|---|---|
| Dissolved fertilizer | UAN (grade 28) | 35.00 | 35.00 |
| Suspended fertilizer | Elemental sulfur | 35.00 | 0 |
| Suspended fertilizer | Calcium Phosphate | 0 | 35.00 |
| Rheology modifier | Xanthan Gum | 0.18 | 0.18 |
| Biocide | Proxel GXL | 0.10 | 0.10 |
| Wetting agent | Alcohol Ethoxylate | 1.50 | 1.50 |
| Dispersant | Lignosulfonate | 3.00 | 0 |
| Dispersant | Sodium Alkyl naphthalene | 0 | 3.00 |
| | sulfonate (Morwet D-425) | | |
| Continuous phase | Water | 25.22 | 25.22 |

| | | |
|---|---|---|
| Total | 100 | 100 |

The formulations of examples 1-5 were subjected to stability testing at 54° C. for 14 days in a closed container. It was found that they exhibited less than 10% (by total height of the formulation) of water layer development, and it was found that pH was stable (less than 0.5 pH value difference), thiosulfate content was stable (less than 0.5% wt. % difference) and viscosity was stable (less than 10% difference). Viscosity was determined before and after the test using the viscosity protocol defined herein elsewhere.

The formulations of examples 1-16 were subjected to 6-month stability testing at room temperature, being stored in identical containers without any agitation being applied during the period of stability testing. It was found that they exhibited less than 10% (by total height of the formulation) of water layer development, and it was found that pH was stable (less than 0.5 pH value difference), thiosulfate content was stable (less than 0.5% wt. % difference) and viscosity was stable (less than 10% difference). Viscosity was determined before and after the test using the viscosity protocol defined herein elsewhere.

The pH of the formulations of examples 1-16 was in the range of 7.5-8.5.

Examples 13 and 14 correspond to the formulation of example 12 with a small amount of potassium thiosulfate or ammonium thiosulfate additionally included. It was observed that when identical amounts of examples 12-14 were stored in identical containers for 6 months at room temperature, the water layer developed on each of formulations 13 and 14 was less than 50% of the water layer developed on formulation 12.

Testing of stability of gypsum suspensions using lota-Carrageenan, kappa-Carrageenan, Alginic acid, Sclerotium gum, and Phyto-gel showed that, although it was possible to obtain a stable suspension, a rheology modifier selected from starch or a derivative thereof, xanthan gum or a derivative thereof, guar gum or a derivative thereof provided surprising further improved stability.

### Comparative Example

A formulation corresponding to the formulation of example 4 was prepared but employing attagel clay as rheology modifier. No stable suspension was achieved.

1. A stable aqueous liquid fertilizer comprising:
water;
a first fertilizing ingredient dissolved in the aqueous liquid;
a solid suspended in the aqueous liquid, wherein the solid comprises calcium; and
a rheology modifier;
wherein the fertilizer ingredient, suspended solid and rheology modifier are different compounds; and
characterized in that the suspended solid has a Dv(25) of 5 micron or more and a Dv(75) of 100 micron or less as determined by laser diffraction.

2. The fertilizer of claim 1 comprising
10-90 wt. % (by total weight of the liquid fertilizer) water;
at least 5 wt. % (by total weight of the liquid fertilizer) of the first fertilizing ingredient dissolved in the aqueous liquid;
at least 10 wt. % (by total weight of the liquid fertilizer) of the solid suspended in the aqueous liquid; and
at least 0.01 wt. % (by total weight of the liquid fertilizer) of the rheology modifier.

3. The fertilizer of claim 1, comprising the rheology modifier in an amount such that the fertilizer has a viscosity within the range of 1000-4000 mPa*s (cps).

4. The fertilizer of claim 1, wherein the first fertilizing ingredient is a source of N, P, K and/or S employed in an amount such that the total combined amount of N, P, K and S provided by the first fertilizing ingredient is more than 5 wt. % (by total weight of the formulation), preferably more than 10 wt. %.

5. The fertilizer of claim 1, wherein the first fertilizing ingredient is selected from the group consisting of thiosulfate salts, urea, ammonium salts, nitrate salts and combinations thereof.

6. The fertilizer of claim 1, wherein the solid comprises a calcium salt selected from the group consisting of sulfates, phosphates, carbonates, hydrates thereof and combinations thereof.

7. The fertilizer of claim 1, wherein the solid comprises gypsum and/or monocalcium phosphate.

8. The fertilizer of claim 1 wherein the solid has the following particle size characteristics:
approximately 100 wt. % of particles pass through a 50 mesh (297 micron) screen, preferably through a 100 mesh (149 micron) screen; and
more than 85 wt. % of particles pass through a 100 mesh (149 micron) screen, preferably through a 200 mesh (74 micron) screen; and
more than 50 wt. % of particles pass through a 200 mesh (74 micron) screen, preferably through a 325 mesh (44 micron) screen.

9. The fertilizer of claim 1, further comprising 0.05-10 wt % (by total weight of the liquid fertilizer) of a dispersant, preferably 0.1-8 wt. %, more preferably 0.5-5 wt. %, wherein the dispersant consists of one or more anionic surfactants selected from salts of a compound represented by R—X; wherein X represents a sulfate group, a phosphate group, a sulfonate group, or a carboxylate group, and wherein R is selected from:
branched or straight-chain C5-C24 alkyls;
branched or straight chain mono-unsaturated C5-C24 alkenyls;
branched or straight chain poly-unsaturated C5-C24 alkenyls;
alkylbenzene groups comprising a C1-C15 alkyl;
alkenylbenzene groups comprising a C2-C15 alkenyl;
alkylnaphthalene groups comprising a C1-C15 alkyl;
alkenylnaphthalene groups comprising a C2-C15 alkenyl;
alkylphenol groups comprising a C1-C15 alkyl;
alkenylphenol groups comprising a C2-C15 alkenyl;
succinic acid esters comprising two C8-C15 alkyls;
ethoxylated C5-C24 alkyls;
C5-C24 fatty acid methyl esters, optionally comprising one or more hydroxyl groups; and
lignins.

10. The fertilizer of claim 9 wherein the dispersant is selected from the group consisting of:
sulfonates of branched or straight-chain C5-C24 alkyls;
sulfonates of alkylnaphthalene groups comprising a C1-C15 alkyl;
sulfonates of alkylbenzene groups comprising a C1-C15 alkyl;
phosphate esters of ethoxylated C5-C24 alkyls;
lignosulfonates; and
combinations thereof.

11. The fertilizer claim 1, wherein the rheology modifier is selected from the group consisting of naturally occurring clays, naturally occurring polysaccharides and derivatives thereof, proteins, synthetic polymers, and combinations thereof,
wherein the derivatives of naturally occurring polysaccharides are selected from naturally occurring polysaccharides modified with acetate, carboxymethyl, hydroxypropyl, hydroxypropylmethyl, methyl, hydroxyethyl, hydroxymethyl, ethylene glycol, or propylene glycol.

12. The fertilizer of claim 11 wherein the rheology modifier is a polysaccharide rheology modifier selected from the group consisting of acacia gums, agar, arabic gums, arabinan, alginic acid or a salt thereof, apiogalacturonan, arthrobacter viscosus NRRL 1973 Exopolysaccharide, arthrobacter stabilis NRRL B3225 Exopolysaccharide, carrageenans, celluloses (e.g. MCC, CMC, MC and HPMC), chitin, chitosan, chondroitin sulfates, fucosylated chondroitin sulfates, colominic acid or a salt thereof, curdlan, dermatan sulfates, dextrans, diutan gums, fructans (e.g. inulins), fucoidans, furcellaran, gellan gums, ghatti gum, glycogen, hemicelluloses (e.g. mannans, galactomannans, xyloglucans, xylans, glucomannans, arabinoxylans, β-glucans (in particular from cereal, yeast, or fungi), arabinogalactans), hyaluronic acid or a salt thereof, ivory nut mannan, konjac, karaya gum, laminaran, levan, lichenan, isolichenan, locust bean gums, mucilage gums (e.g. yellow mustard mucilage, flaxseed mucilage, pysillium gum), pachyman, pachymaran, pectin, pectic arabinogalactans, pectic rhamnogalacturonans, peptidoglycan, polysialic acid or a salt thereof, porphyran, pullulan, putstulan, schizophyllans, scleriotium gums, scleroglucan, starches, tamarind gum, tara gum, teichuronic acids, tragacanth gum, ulvan, welan gum, xanthan gums, xylans, zymosan, derivatives thereof and combinations thereof, wherein the derivatives are selected from the aforementioned polysaccharides modified with acetate, carboxymethyl, hydroxypropyl, hydroxypropylmethyl, methyl, hydroxyethyl, hydroxymethyl, ethylene glycol, or propylene glycol.

13. The fertilizer of claim 1, wherein the rheology modifier, when added to demineralized water at a concentration of 1 g/100 ml water, results in a viscosity of more than 200 cps.

14. The fertilizer of claim 12, wherein the rheology modifier is selected from the group consisting of starch or a derivative thereof, xanthan gum or a derivative thereof, guar gum or a derivative thereof, diutan gum or a derivative thereof, locust bean gum or a derivative thereof, and combinations thereof,
wherein the derivatives are selected from the aforementioned polysaccharides modified with acetate, carboxymethyl, hydroxypropyl, hydroxypropylmethyl, methyl, hydroxyethyl, hydroxymethyl, ethylene glycol, or propylene glycol.

15. The fertilizer of claim 1, further comprising 0.05-10 wt % (by total weight of the liquid fertilizer) of a wetting agent, preferably 0.1-5 wt. %, more preferably 0.5-2 wt. %, wherein the wetting agent is a non-ionic surfactant selected from the group consisting of alcohol ethoxylates, fatty acid ethoxylates, ethoxylated amines, ethoxylated fatty acid amides, poloxamers, fatty acid esters of glycerol, fatty acid esters of sorbitol, fatty acid esters of sucrose, alkyl polyglucosides and combinations thereof.

16. A method for the preparation of a fertilizer comprising the steps of:
(i) providing an aqueous liquid comprising a first fertilizing ingredient salt dissolved therein;
(ii) adding to the aqueous liquid provided in step (i) a solid comprising calcium and a rheology modifier to obtain a first blend, wherein the fertilizer ingredient salt, the solid comprising calcium, and the rheology modifier are different compounds; and
(iii) submitting the first blend of step (ii) to a mixing step suitable for converting it into a stable aqueous liquid fertilizer, wherein the suspended solid has a Dv(25) of 5 micron or more and a Dv(75) of 100 micron or less as determined by laser diffraction.

17. The method of claim 16 wherein the aqueous liquid provided in step (i) contains:
ammonium thiosulfate in an amount resulting in a nitrogen content (as ammoniacal nitrogen) of more than 10 wt. % (by total weight of the aqueous liquid provided in step (i)) and a sulfur content of more than 26 wt. % (by total weight of the aqueous liquid provided in step (i)); or
potassium thiosulfate in an amount resulting in a potassium content (as K2O) of more than 22 wt. % (by total weight of the aqueous liquid provided in step (i)) and a sulfur content of more than 15 wt. % (by total weight of the aqueous liquid provided in step (i));
calcium thiosulfate in an amount resulting in a calcium content of more than 5 wt. % (by total weight of the aqueous liquid provided in step (i)) and a sulfur content of more than 8 wt. % (by total weight of the aqueous liquid provided in step (i)); or
magnesium thiosulfate in an amount resulting in a magnesium content of more than 3 wt. % (by total weight of the aqueous liquid provided in step (i)) and a sulfur content of more than 8 wt. % (by total weight of the aqueous liquid provided in step (i));
wherein preferably the aqueous liquid provided in step (i) contains:
ammonium thiosulfate in an amount resulting in a nitrogen content (as ammoniacal nitrogen) of more than 10 wt. % (by total weight of the aqueous liquid provided in step (i)) and a sulfur content of more than 26 wt. % (by total weight of the aqueous liquid provided in step (i)).

18. A method of fertilization comprising:
applying a liquid fertilizer composition wherein the liquid fertilizer composition comprises:
water;
a first fertilizing ingredient dissolved in the aqueous liquid;
a solid suspended in the aqueous liquid, wherein the solid comprises calcium; and
a rheology modifier;
wherein the fertilizer ingredient, suspended solid and rheology modifier are different compounds;
characterized in that the suspended solid has a Dv(25) of 5 micron or more and a Dv(75) of 100 micron or less as determined by laser diffraction; and
wherein applying includes side dress, soil injection, spray (soil and/or foliar) or fertigation application.
